(19) United States
(12) Patent Application Publication
(10) Pub. No.: US 2009/0283351 A1
(43) Pub. Date: Nov. 19, 2009

(54) GAS STORAGE SYSTEM, METHOD USING SAME, AND VEHICLE INCORPORATING SAME

(76) Inventors: Gilles Cannet, Parmain (FR); Philippe Pisot, L'Isle Adam (FR)

Correspondence Address: AIR LIQUIDE;Intellectual Property, 2700 POST OAK BOULEVARD, SUITE 1800, HOUSTON, TX, 77056, US

(21) Appl. No.: 11/573,419

(22) PCT Filed: Jun. 17, 2005
(86) PCT No.: PCT/FR05/50457

§ 371 Date: Jun. 25, 2009

(30) Foreign Application Priority Data
Aug. 12, 2004 (FR) 0451839

(51) Int. Cl. F17C 1/00; F16L 3/00; F16K 31/02; F17C 13/00

(52) U.S. Cl. 180/302; 137/376; 251/129.15

(57) ABSTRACT

Abstract of the Disclosure The invention concerns a gas storage system, in particular for supplying a motor vehicle power source, comprising at least two storage modules (GrA, GrB, GrC) each including an outlet conduit (Ci) connectable, by a quick-connect device (Cri) via an electromagnetic valve (vpA/B/C), to a supply line (L) of a user station, the modules, including for example different capacities, being produced with identical tanks (Ri). The invention is characterized in that the modules are used sequentially allowing one module to be completely emptied before the other module is used, and in that only the first empty module can be replaced with an identical full module, without replacing, at that stage, the other module in operation.

The present invention relates to gas storage systems for providing gas to a line supplying at least one user station, more particularly but not exclusively for the provision of gas to a power source in a vehicle, typically a motor vehicle, and vehicles incorporating such a system of storing gas, typically natural gas or hydrogen.

Whether for stationary use or use on board a vehicle, the management of gas reserves falls under two general approaches, namely the in-situ loading of a permanent storage unit or the exchange of an empty detachable storage unit for a new full storage unit.

The object of the present invention is to provide systems for storing gas that are simple and low cost, making it possible to optimize the exchange and management of gas consumption.

To this end, according to one feature of the invention, the storage system comprises at least one first and one second individual storage module, each having at least one output line, each of which can be connected by a rapid connection device and via an associated solenoid valve to the supply line.

According to other features of the invention:

the system comprises, upstream of each solenoid valve, a pressure sensor providing an electronic control unit with a pressure signal that is representative of the available gas pressure in the associated module;

the first and second assemblies have different capacities but advantageously comprise identical tanks that are different in number;

each tank is housed in a housing of a chassis that is stationary or that can be moved between at least two positions;

each tank contains a gas under a pressure greater than 120 bar, typically greater than 300 bar;

each tank is associated, at the outlet, with an isolating valve.

The invention also relates to a vehicle using said gas as a power source and incorporating such a storage system.

The object of the present invention is also a method for putting a system of the type defined above into practice, according to which the first of said storage modules is connected to the supply line by opening the solenoid valve of the module concerned and then, after emptying the first module, the second one is connected, the first emptied module being at the same time or subsequently disconnected and replaced by an identical full module.

Other features and advantages of the present invention will become apparent from the following description of embodiments given by way of illustration but in no way limiting, made in relation to the appended drawings, in which:

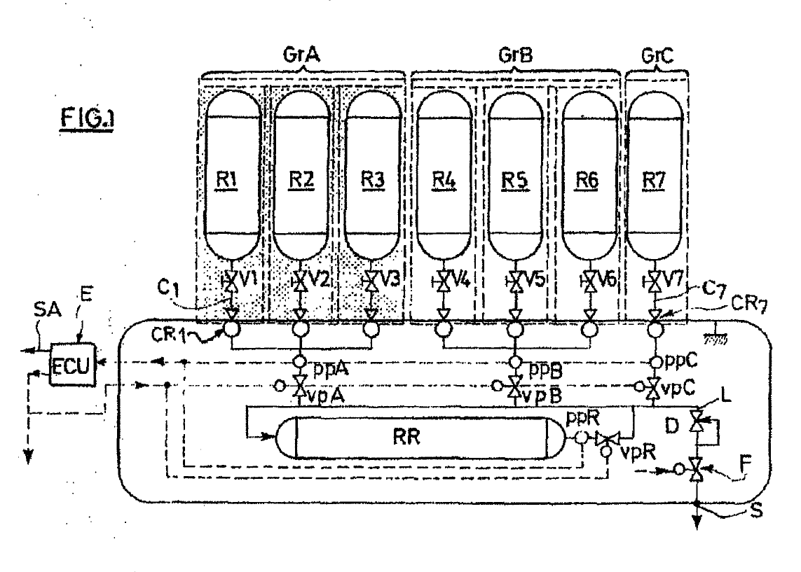

FIG. 1 is a diagrammatic view of an embodiment of a gas storage system according to the invention;

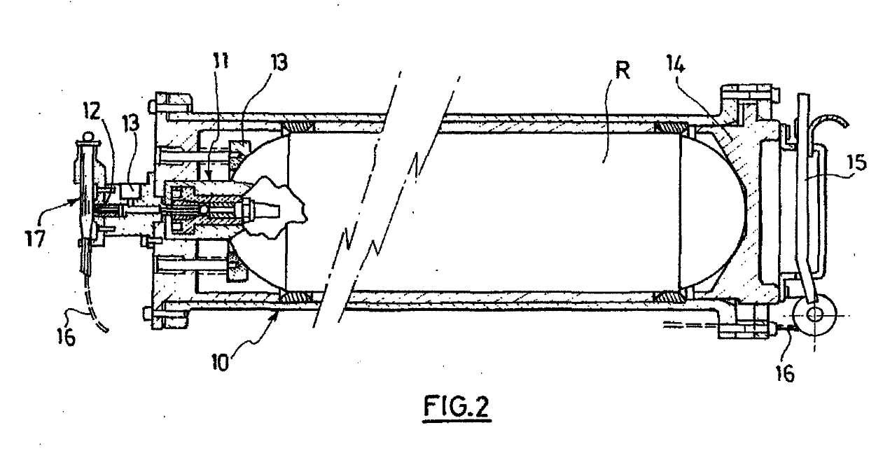

FIG. 2 is a partial longitudinal sectional view of an embodiment of a unit module according to the invention.

In the particular embodiment shown diagrammatically in FIG. 1, a system according to the invention comprises three different gas storage modules GrA, GrB, GrC, at least one of which has a different capacity from the others, but all being made from identical tanks or bottles Rᵢ. In the example shown, two modules (GrA, GrB) consist of three tanks Rᵢ while the third module GrC consists of a single tank R₇.

According to one feature of the invention, each tank Rᵢ is associated with a respective output line Cᵢ incorporating an isolating valve Vᵢ and ending in a plug-in element of a rapid connection device CRᵢ of which the other matching element is connected downstream to a supply line L connected, from an outlet S downstream of a shut-off solenoid valve F, to at least one user station, for example an internal combustion engine and/or a fuel cell of a motor vehicle, in which case the gas is hydrogen.

In the embodiment shown, a solenoid valve vpA/B/C, controlling the connection between the outlets from the rapid connection devices of the modules and the supply line L, is associated with each module GrA/B/C. In addition, upstream of each solenoid valve vpA/B/C, there is associated a pressure sensor ppA/B/C detecting the pressure available at the outlet from the associated module and each transmitting a pressure level signal to an electronic control unit E capable of providing, at its output, signals controlling the solenoid valves vpA/B/C and alarm signals SA actuating for example warning lights on the instrument panel indicating that a module is empty or almost empty and indicating that the solenoid valve vpA/B/C is open.

With such an arrangement, the modules GrA, GrB and GrC are individually removable and the pressure in each module is analyzed by the sensors ppA/B/C of which the data are analyzed by the unit E, the controlled valves vpA/B/C selectively and sequentially controlling the dispatch of gas from a module Gr to the supply line L. After a module is connected, its valves Vᵢ are opened so as to put the contents of the various tanks into communication with the line L. The device according to the invention therefore makes it possible, by successively opening the solenoid valves vpA/B/C to empty sequentially the various modules, so that at the moment gas is provided again, it is possible to replace individually the empty module or modules and only these.

In order to perform this exchange, the corresponding solenoid valve vpA/B/C is closed, and the valves Vᵢ of the module to be exchanged are then closed and the rapid connections CRᵢ are disconnected. A new full module Gr is put in place and the previously described sequence can be repeated. At the same time, after verifying the state of the tank or tanks of the withdrawn module, these tanks are once again filled and stored with a view to a new cycle.

The tanks Rᵢ may contain a gas under a low pressure, adsorbed for example on a support, typically hydrides for providing hydrogen.

The tanks Rᵢ alternatively contain a gas under a high pressure, greater than 120 bar, typically greater than 300 bar, and that can advantageously exceed 400 bar. In this case, the line L is provided with an expansion valve D, upstream of the shut-off solenoid valve F. As a variant, in particular in the case of storage under a high pressure, that can reach 700 bar, the valves Vᵢ are advantageously replaced by on-off pressure reducing valves lowering the pressure of the gas delivered by the tanks Ri to an intermediate level, which makes it possible to make connections under a reduced pressure, with reduced risks of leakages at the moment the full tanks are put in place.

Advantageously, as shown in FIG. 1, the system additionally includes a reserve container RR, permanently installed, arranged in parallel with the upstream part of the supply line L. This reserve container RR is filled from the contents of the detachable storage modules GrA/B/C and empties via a specific controlled valve vpR associated with a pressure sensor ppR, refilling it giving supplementary flexibility to the system with the aim of making it possible to empty completely the various modules GrA/B/C without running the risks of running out of gas.

FIG. 2 shows an embodiment of a tank R that can be housed in a fixed chassis 10 of a module Gr such as previously described. The tank R is made in the form of a bottle, incorporating in its neck 11 a rapid connection device with a non-return valve that can be actuated by a plunger 12 sliding in the chassis 10.

In this embodiment, the tank R is mounted in a housing of the chassis 10 while coming to bear, by its front face, against a receiving ring with elastic support 13 and is locked in place by a base 14 mounted in the chassis and comprising a locking lever 15 actuating, as it tilts, a cable 16 moving a cam rod 17 cooperating with the plunger 12 opening the communication between the tank R and the gas outlet 13 when the tank R is in position in the chassis 10 and blocking this communication as soon as the lever 15 is actuated with a view to extracting the tank R from its housing.

Although the invention has been described in relation to particular embodiments, it is not limited thereto but is capable of modifications and variants which will be apparent to a person skilled in the art within the framework of the following claims.

1-14. (canceled)

15: A gas storage system for providing gas to a line supplying at least one user station, comprising at least one first and one second storage module, each having at least one output line, each of which can be connected by a rapid connection device and via an associated solenoid valve to the supply line.

16: The system of claim 15, wherein it comprises, upstream of the solenoid valve, a pressure sensor providing an electronic control unit with a pressure signal.

17: The system of claim 15, wherein the first and second modules have different capacities.

18: The system of claim 15, wherein the first and second modules comprise identical tanks.

19: The system of claim 18, wherein each tank is received in a housing of a stationary chassis of the module.

20: The system of claim 18, wherein the tanks are mounted on a chassis that can be moved between at least two positions.

21: The system of claim 18, wherein each tank is associated, at the outlet, with an isolating valve.

22: The system of claim 15, wherein it includes a reserve tank in parallel with the supply line.

23: The system of claim 15, wherein each storage module contains a gas under a pressure greater than 120 bar.

24: The system of claim 23, wherein the supply line includes an expansion valve.

25: A vehicle using said gas as a power source, incorporating a system of claim 15.

26: A method for putting a system of claim 15 into practice, wherein one of said storage modules, and then, after emptying, another of said modules, is connected to the supply line.

27: The method of claim 26, wherein the first emptied module is disconnected and replaced by an identical full module.

28: The method of claim 26, wherein the gas is hydrogen.
